(19) United States
(12) Patent Application Publication
(10) Pub. No.: US 2025/0239171 A1
(43) Pub. Date: Jul. 24, 2025

(54) ENHANCED GRADING AND FEEDBACK ASSISTANT SYSTEM FOR HANDWRITTEN STUDENT WORK

(71) Applicant: GoodNotes Limited, London (GB)

(72) Inventors: Gabriel Jourdan, London (GB); Ngo Tan Trung, Ho Chi Minh City (VN); Mubarak Mohammed Marafa, Hong Kong (CN); Kwok Tsz Lok, Hong Kong (CN); Hung Lok Shun, Hong Kong (CN); Animesh Fatehpuria, Taipei City (TW); Kim Johanna Maria Feenstra Kuiper, Are (SE); Gerardo Jesús Lastra Madrid, Madrid (ES); Abhishek Aggarwal, London (GB); Edward Bradley, Worthing (GB); Rowena Chung Petersen, Hong Kong (CN); Chelsea Luna Mangold-Takao, Munich (DE); Cheung Wan Yi, Hong Kong (CN)

(73) Assignee: GoodNotes Limited, London (GB)

(21) Appl. No.: 19/034,719

(22) Filed: Jan. 23, 2025

Related U.S. Application Data
(60) Provisional application No. 63/624,140, filed on Jan. 23, 2024.

(51) Int. Cl. G09B 7/00; G06F 16/35; G06T 11/60; G06V 30/18

(52) U.S. Cl. CPC G09B 7/00; G06F 16/35; G06T 11/60; G06V 30/1801

(57) ABSTRACT

This disclosure describes systems, methods, and devices for artificial intelligence-based grading and feedback of digitally entered handwritten characters into a device. A method may include converting, using a first device, a computer-readable document with questions into a digital worksheet comprising teacher layers and student layers; detecting, using a first machine learning model trained to categorize questions and generate answer zones for the questions, answer zones; generating first updated student layers comprising the questions and the answer zones; receiving second updated student layers comprising the first updated student layers and respective answers digitally handwritten into the answer zones; generating, using a second machine learning model, clusters of the respective answers based on hand stroke similarities in the respective answers and based on content similarities in the respective answers; and presenting, using the first device and the teacher layers, the respective answers based on the clusters.

### CROSS-REFERENCE TO RELATED APPLICATION(S)

This application claims the benefit of U.S. Provisional Application No. 63/624,140, filed Jan. 23, 2024, the disclosure of which is incorporated herein by reference as if set forth in full

### TECHNICAL FIELD

Embodiments of the present invention generally relate to systems and methods for organizing handwritten student answers from separate computer-readable documents to facilitate grading and feedback for the answers.

### BACKGROUND

Devices may allow users to handwrite text rather than enter text using keystrokes. Users may be provided a document with questions that they can answer. Organizing computer-readable documents with answers handwritten on a computer device can be challenging, especially for grading the answers.

### BRIEF DESCRIPTION OF THE DRAWINGS

FIG. 1 illustrates an example process for grading and feedback of answers that are handwritten using devices, in accordance with one embodiment.

FIG. 2 illustrates an example aggregation of student answers for a teacher annotation mode, in accordance with one embodiment.

FIG. 3 illustrates an example process for artificial intelligence-based grouping of the questions of FIG. 1 for teacher presentation, in accordance with one embodiment.

FIG. 4 illustrates an example system for grading and feedback of answers that are handwritten using devices, in accordance with one embodiment.

FIG. 5 illustrates an example process for grading and feedback of answers that are handwritten using devices, in accordance with one embodiment.

FIG. 6 illustrates an example process for grading and feedback of answers that are handwritten using devices, in accordance with one embodiment.

FIG. 7 illustrates an example process for grading and feedback of answers that are handwritten using devices, in accordance with one embodiment.

FIG. 8 illustrates an example process for generating answer zone groups, in accordance with one embodiment.

FIG. 9 is an example schematic diagram of one or more artificial intelligence models that may be used for the assessment and correction of text that is handwritten into a computer device, in accordance with one embodiment.

FIG. 10 is a flow for an example process for artificial intelligence-based grading and feedback of digitally entered handwritten characters into a device, in accordance with one embodiment.

FIG. 11 is a diagram illustrating an example of a computing system that may be used in implementing embodiments of the present disclosure.

FIG. 12 illustrates an example neural network, in accordance with one or more embodiments.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

Aspects of the present disclosure involve systems, methods, and the like, for grading and feedback of handwritten answers using devices.

Devices may allow users to input characters in a variety of ways, such as with keystrokes and stylus strokes. When a user enters a keystroke (e.g., using a keyboard), the keystroke is converted to a corresponding character, such as a letter, number, symbol, or punctuation mark. When a key is pressed on a keyboard, it is converted into a binary number that represents a character, so there is no ambiguity in determining which character a user typed with a keystroke. In contrast, when a user handwrites text into a computer device with an electronic device or a user's finger, such as with a stylus or their finger, many variations in the handwriting introduce ambiguity when determining what characters the handwriting represents. Analyzing characters handwritten into a device, therefore, depends on the ability of the computer device to correctly identify the characters represented by the handwriting.

Humans may identify and categorize handwritten characters after seeing only a few examples, but a machine's ability to identify and categorize handwritten characters may require significantly more examples to train. An electronic device encompasses a broad array of electronic gadgets, including tools such as a digital stylus or any comparable apparatus, which permit the user to sketch characters on a computer interface as a form of hand-drawn or handwritten input. Beyond the use of an electronic device for inputting strokes onto the computer device, users can also engage the intuitiveness of their own fingers as a dynamic and natural means to accomplish the same task, thus providing a more direct and tactile interaction with the digital interface. Throughout this disclosure, while electronic devices are primarily illustrated as examples, it should be understood that the scope of interaction is not limited to these alone. A user's finger also serves as a viable tool for interacting with computer devices. Hence, the exemplification of an electronic device should not be misconstrued as a limitation, but rather, it serves as one among many possible methods for interaction in the broader digital landscape. A computer device, such as a laptop, tablet, or smartphone, can be described as a sophisticated system equipped with an interactive interface designed to accept and interpret strokes from an electronic device, recording these inputs as lines, characters, shapes, and more. This interaction transforms abstract human action into digitized elements.

To allow a computer device to analyze characters handwritten into the computer device, correctly identifying the handwritten text is important to a computer device's ability to assess the words represented by the handwritten text. If the computer device improperly identifies handwritten words such as answers to questions, then the computer device may not correctly analyze whether the answers are correct.

A computer device-based analysis of handwritten characters also must be able to process the characters identified from the handwritten inputs to the computer device, and recognize that they represent words and sentences forming questions and answers. The list of supported languages for handwriting recognition and question and answer analyses includes but is not limited to English, German, French, Spanish, Portuguese, Italian, Dutch, Chinese, Japanese, Korcan, Thai, Russian, and Turkish. The list of supported languages includes but is not limited to English, German, French, Spanish, Portuguese, Italian, Dutch, Thai, Russian and Turkish.

Traditional methods of grading and providing feedback on handwritten student responses are time-consuming and prone to inconsistency. There is a need for a system that efficiently manages digital worksheets into which users may enter handwritten text via a computer device, automates the recognition and analysis of handwritten answers, and facilitates streamlined grading of the answers while preserving a student's ability to use handwriting to answer questions in ways that would not be possible using an indirect manipulation with keyboard and mouse.

In one or more embodiments, the enhanced techniques herein may perform automatic detection of questions in a digital document (e.g., a .pdf or other computer-readable document), automatic prediction of digital document space to allow for handwritten answers to detected questions, real-time recognition and analysis of handwritten answers, clustering of similar answers for batch grading, and presenting a comparative view of handwritten responses for a grader.

For example, a teacher may import and create digital worksheets and other documents that may include questions and/or exercises for students. Using a collaborative framework, the documents may be shared (e.g., among multiple students in a class) so that multiple users may access the digital documents on their user devices. Edits, including handwritten inputs, may be synchronized in real-time among participants. Each student joining the digital document may receive their own digital editing layer, which may allow teachers to identify who made each edit while preventing students from seeing each other's work. Teachers may access the student layers and annotate them to provide feedback to respective students.

In one or more embodiments, a question detection system may execute on an imported or created document from a teacher to detect questions in the document. The question detection system may use a combination of machine learning techniques such as optical character recognition (OCR), large language model (LLM), and document layout analysis, along with image processing algorithms, to identify questions or exercises in the digital pages. The question detection system may identify the type of question and predict the space in the document that the student would need to enter a handwritten response based on the question type and the content of the question.

In one or more embodiments, visible bounding boxes (e.g., answer zones) may be placed automatically around the question in the digital document with respect to the predicted space needed for answering. The answer zones may allow the teacher to display the digital worksheet in different ways to support faster grading, such as by viewing all student answers to a same question in a single view rather than needing to move between student layers or interfaces for each student to view the same answer on each student's layer. A comparative question view may render the area captured by an answer zone from each participant's layer in a single view and may allow a teacher to annotate them so that each student may receive answer feedback that is not presented in a layer of another student (e.g., each student only sees their answer and the teacher's feedback for their answer).

In one or more embodiments, OCR, handwriting recognition, and diagram classification may be applied to student responses in real-time. A computer device may receive handwritten strokes on a screen or touchpad, such as with a stylus or a user's finger, representing handwritten characters. The computer device may analyze the handwritten strokes to identify the characters represented by the handwritten strokes based on the X and Y coordinates of the strokes on the computer device. The computer device may determine a confidence level in the recognized handwritten characters and in a suggested word. If the confidence score of the recognized text exceeds a confidence threshold for representing certain characters, such may indicate that the recognized text is likely to represent a particular identified set of characters. By recognizing the handwritten characters and understanding the meaning of the content of the answers represented by the handwritten characters, teachers may group handwritten student answers by similarity (e.g., certain answers to a question may be similar to each other and different from other answers to the same question). This may allow teachers to provide feedback faster and to recognize patterns in student responses, which teachers may use to adjust the flow of a live lesson.

In one or more embodiments, the enhanced techniques herein may facilitate interactions between teacher and students during and outside of class time, including for assignment creation and submission, returning of student answers, and grading and feedback from teacher to students.

In one or more embodiments, a .pdf (e.g., .pdf file extension) worksheet may be extended to add individual layers for students. For example, each student may use one or more layers of a digital document such as a .pdf document for entering handwritten answers to questions/exercises without other students accessing and viewing another student's layer(s). For example, a teacher may create or import a digital worksheet, and the system herein may convert the worksheet to one with multiple layers. The layer that includes questions may be referred to as the base layer (e.g., a .pdf base layer), which may be read-only for students and editable for the teacher. Student layers on top of the base layer may be editable to allow students to digitally handwrite into the answer zones. The student layer(s) may be arranged on top of the base document of the teacher that is the digital document with the questions/exercises. The student layers for answers may include the answer zones predicted for the respective questions/exercises. Students may handwrite, digitally, their answers into the answer zones, allowing the system herein to identify and analyze the text in the answer zones.

In one or more embodiments, a teacher may use a device to trigger the automatic detection of questions/exercises in the digital worksheet and manually may adjust the answer zones for the respective questions/exercises. The answer zone may be classified and tagged into one of multiple predefined categories of questions/exercises, such as true/false, multiple choice, free-form answer, fill-in-the-blank, and the like. The size of an answer zone may be based on the category of question/answer. In this manner, answer zone sizes may vary.

In one or more embodiments, the system herein may use a protocol to connect students and teachers (e.g., participants) to send and receive updates to and from their individual layers of the digital worksheet, and to propagate the individual layers across the respective participants. For example, a teacher may share a link asynchronously (e.g., via email or other messaging), or may present a QR code to students, who may scan the QR code with a device and be redirected to a location of the worksheet. Any edits entered by teachers or students may be synchronized in real-time among the participants so that they all may be presented with the edits in their respective layers.

In one or more embodiments, the system herein may use a dynamic role-based access control system to control the reading and editing permission of the layers based on a participant's role (e.g., student or teacher), and which may be triggered by key events such as assignment, submission by a student, feedback annotation entered by the teacher, and the like. The teacher role may view/edit the base document and the teacher's own layer and may view and edit answer zones within all the layers (e.g., so the teacher may view all student layers). The student role may have view-only access to the base document and, optionally, to the teacher's layer if shared by the teacher, and may have view and edit access to their own student layer(s).

In one or more embodiments, the system herein may provide a comparative and aggregative view of handwritten student responses entered into the respective student layers of the digital worksheet. The system may aggregate the answer zones of respective questions from each student (e.g., aggregate each student's answer to question 1, etc.) to generate a list-like view that presents to the teacher multiple answers from different students to a single answer in sequential order (e.g., one student's answer to question X, another student's answer to question X, etc.) instead of presenting all of the answers from one student in a layer and all of the answers from another unit in another layer so that the teacher would otherwise have to switch between different student layers to see each student's answer to a single question. The aggregate view may form clusters of similar answers to any given question to facilitate batch grading of the answers. For example, some answers to a question provided by different students may be similar to one another, while other answers to the same question provided by other students may be different. In this manner, the order in which the student answers to the same question are presented to the teacher may be based on the similarities (e.g., one cluster of similar answers is presented before another cluster of answers and/or disparate answers).

Among other technical advantages noted above, the enhancements herein allow for a teacher to create or import a digital document with questions, without having to create or designate answer zones (e.g., areas in which students are to provide their answers to the questions) because the machine learning may predict the amount of space needed for the answers and may generate the answer zones. In this matter, the digital document does not need any answer zones (e.g., does not require a teacher to digitally format the document to allow for answer zones), but rather the machine learning generates the answer zones based on the question categories and uses the answer zones to create student zones that include both the questions and the answer zones into which the students may digitally enter their answers. The enhanced techniques also remove the need for a teacher to move between digital interfaces of the different students' answers, allowing for the grouping of the same questions for multiple students to be presented to a teacher for simpler batch grading. Similarly, the enhancements herein allow for annotations to digitally enter answers grouped based on the question and their similarities so that a teacher may not need to repeat or otherwise replicate their comments on one answer for another similar answer to the same question.

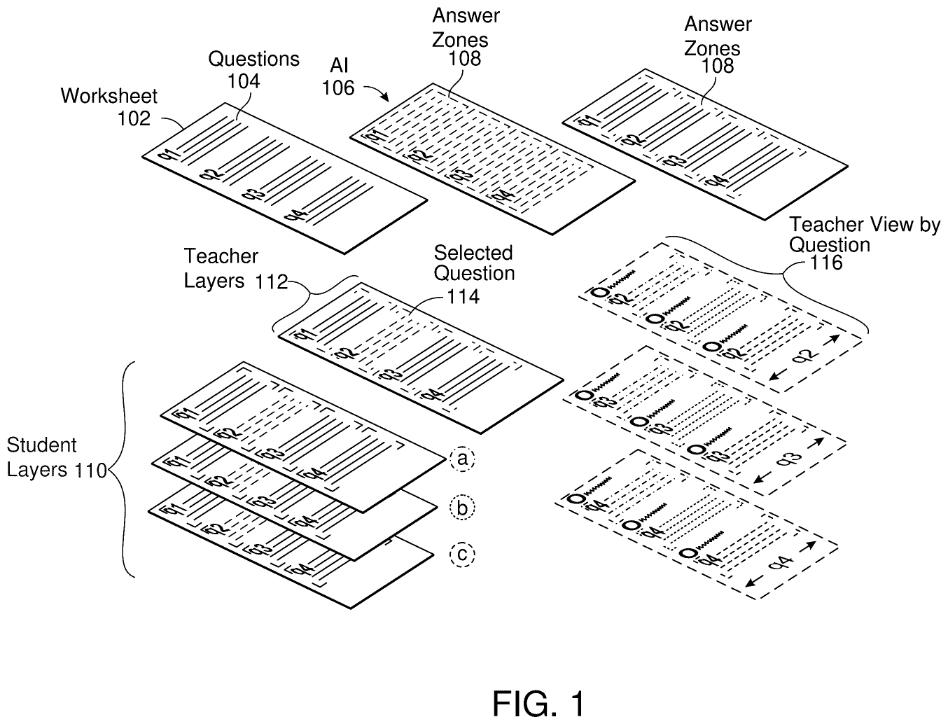

The above descriptions are for the purpose of illustration and are not meant to be limiting. Numerous other examples, configurations, processes, etc., may exist, some of which are described in greater detail below. Example embodiments will now be described with reference to the accompanying figures. FIG. 1 illustrates an example user interface for real-time assessment and correction of text that is handwritten using a device, in accordance with one embodiment.

FIG. 1 illustrates an example process for grading and feedback of answers that are handwritten using devices, in accordance with one embodiment.

Referring to FIG. 1, a teacher may create or upload a worksheet 102 to a device. The worksheet 102 may include questions 104 (and/or exercises) for a student to complete/answer by handwriting answers digitally into another device. AI 106 may be used to identify the questions 104 of the worksheet 102 (e.g., questions 91-94 as shown in FIG. 1). When the questions 104 are identified by the AI 106, the AI 106 may predict the amount of space needed for a student to enter an answer to the questions 104. Based on the space predictions, the AI 106 may generate answer zones 108 for the questions 104 (e.g., designated areas of the worksheet 102 into which to input handwritten answers). Based on the questions 104 and the answer zones 108, student layers 110 may be generated for each student receiving the worksheet 102 (e.g., layer a for student a, layer b for student b, layer c for student c, etc.). Any respective student of the teacher may receive one or more layers specific to that student and not viewable by another student. A respective layer of the student layers 110 may present the questions 104 with their respective answer zones 108 so that a student may handwrite answers into the answer zones 108.

Still referring to FIG. 1, the teacher may be presented with teacher layers 112 that may include all or a subset of the student layers 110 so that the teacher may see any of the students' answers entered into the student layers 110. The teacher may select a question of the questions 104 (e.g., selected question 114), and in response, the answers to the selected question may be aggregated from the student layers 110 and presented sequentially in the teacher layers 112 (e.g., a teacher view by question 116) so that the teacher may view any and all of the answers to the selected question without having to move between different student layers and answers to different questions.

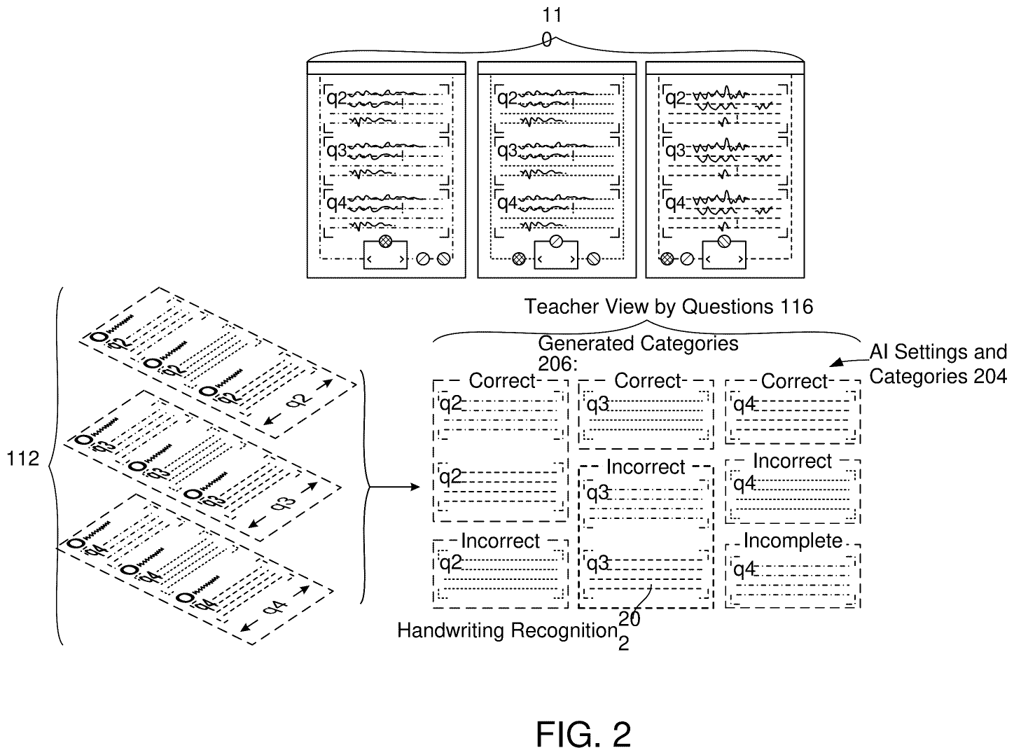

FIG. 2 illustrates an example aggregation of student answers for a teacher annotation mode, in accordance with one embodiment.

Referring to FIG. 2, the student layers 110 are shown with handwritten answers to the questions (e.g., the questions 104 of FIG. 1). The teacher layers 112 may include the answers from the student layers 110 presented as groups of answers to a single question in sequential order (e.g., answers to question q2 grouped together as shown, answers to question q3 grouped together as shown, answers to question q4 grouped together as shown, etc.). Handwriting recognition 202 may be applied to the student layers 110 to identify digitally handwritten answers (e.g., in the answer zones 108 of FIG. 1.). The digitally handwritten answers may be analyzed by AI 204 for settings and categories. For example, the AI may be trained to recognize correct and incorrect answers, and/or to identify similarities in the content of the answers so that the answers may be grouped together in generated categories 206 based on being correct/incorrect, and/or having similarities in the content. In this manner, a teacher view 116 organized by questions may group the questions and answers of the student layers 110 by categories (e.g., correct and/or similar answers to respective questions, incorrect and/or similar answers to respective questions), allowing the teacher to batch-grade the answers by viewing aggregated answers that are similar (e.g., to provide an indication for a group of correct/incorrect answers showing that they are correct/incorrect, to provide comments/mark-ups that may apply to multiple similar answers, etc.).

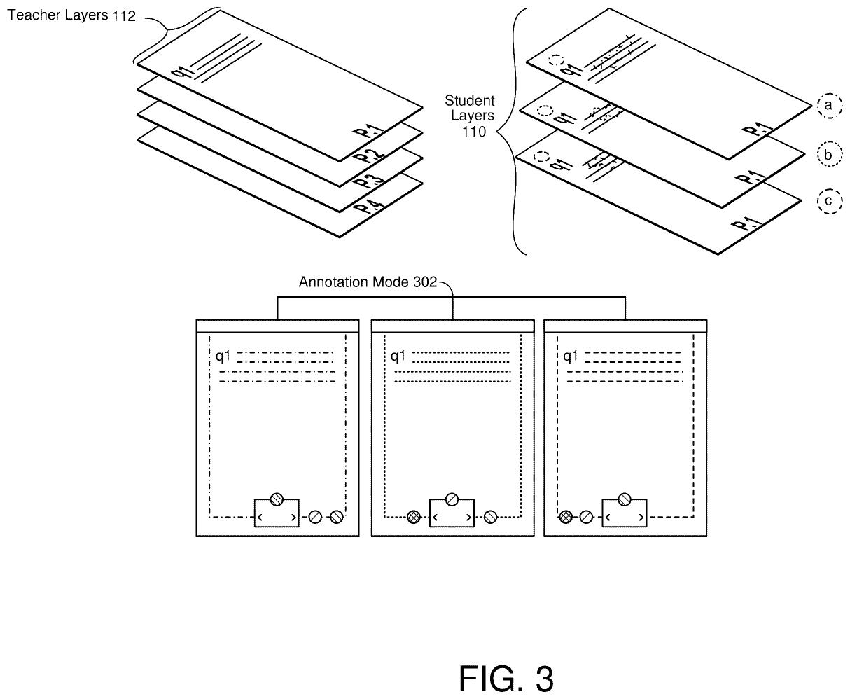

FIG. 3 illustrates an example process for artificial intelligence-based grouping of the questions 104 of FIG. 1 for teacher presentation, in accordance with one embodiment.

Referring to FIG. 3, the student layers 110 may be aggregated by question (e.g., question q1 on respective page 1 as shown) to facilitate an annotation mode 302 for the teacher layers 112 such that the teacher layers 112 group the answers to respective questions as shown in FIG. 2. In the annotation mode 302, the teacher may annotate (e.g., using digital handwriting inputs) the answers to the questions grouped together for the teacher layers 112 to facilitate batch grading. For example, annotation to an answer grouped with other same/similar answers may be automatically applied to each answer in a group of answers so that the teacher does not need to repeat the same edits/comments for each same/similar answer.

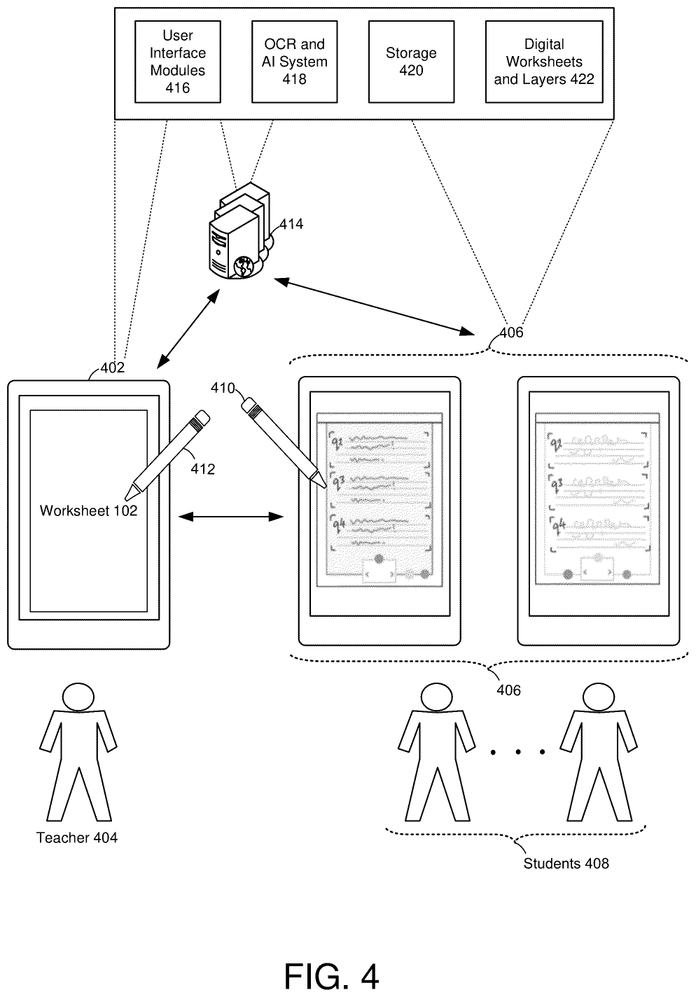

FIG. 4 illustrates an example system 400 for grading and feedback of answers that are handwritten using devices, in accordance with one embodiment.

Referring to FIG. 4, the system 400 may include a device 402 with which a teacher 404 may create or input the worksheet 102, and devices 406 for students 408. The devices 406 may present the student layers 110 for each student, and allow the students 408 to enter handwritten text (e.g., via fingers, a stylus 410, etc.). Similarly, the device 402 may receive handwritten inputs from the teacher 404 (e.g., via fingers, a stylus 412, etc.). The device 402 may communicate with the devices 406 using a peer-to-peer communication protocol and/or may communicate through one or more remote servers 414 (e.g., a cloud-based network) to send the worksheet 102, provide the student layers 110 of FIG. 1 to the devices 406, receive the student answers from the student layers 110 of FIG. 1, and to provide annotations and answers to the students via the devices 406.

Still referring to FIG. 4, the devices 402, the devices 406, and or the one or more remote servers 414 may include user interface models 416 (e.g., for generating user interfaces at the device 402 and/or the device 406 for presenting worksheets and layers), an COR and AI system 418 (e.g., for performing digital handwritten text recognition and analysis), and storage 420 (e.g., for storing digital worksheets and layers 422). In this manner, the logic and AI herein may be performed locally on the device 402 and the devices 406, and/or on the one or more remote devices 414.

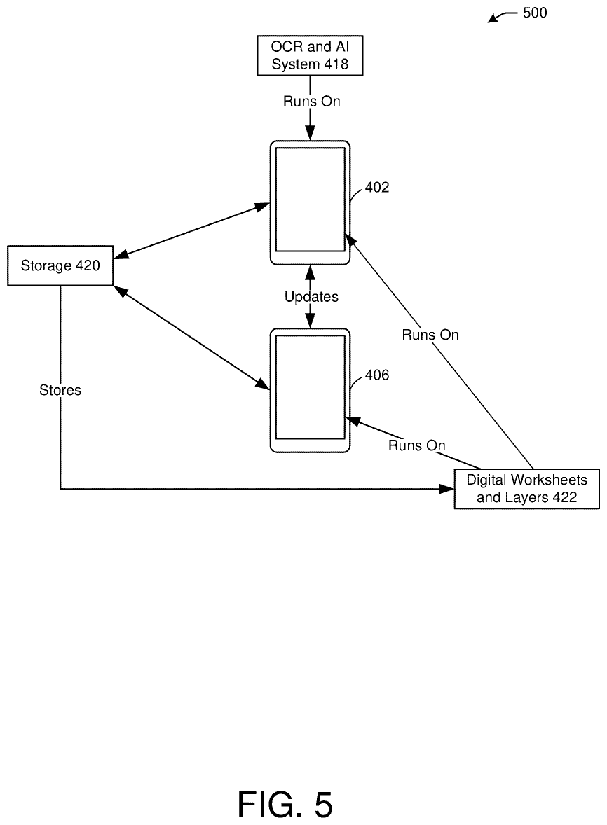

FIG. 5 illustrates an example process 500 for grading and feedback of answers that are handwritten using devices, in accordance with one embodiment.

Referring to FIG. 5, the OCR and AI system 418 may run on the device 402 (e.g., of the teacher 404 of FIG. 4). The device 402 and the devices 406 (e.g., of the students 408 of FIG. 4) may use the storage 420, which may store the digital worksheets and layers 422. The digital worksheets and layers 422 may run on the device 402 and the devices 406, which may update cach other (e.g., with answers, annotations, etc.).

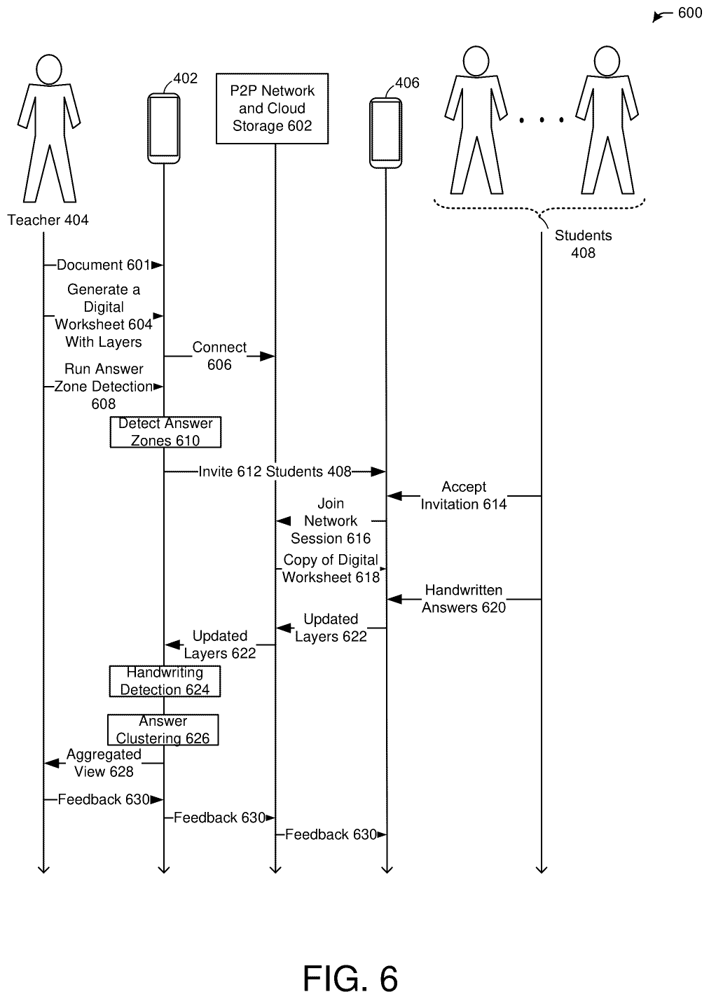

FIG. 6 illustrates an example process 600 for grading and feedback of answers that are handwritten using devices, in accordance with one embodiment.

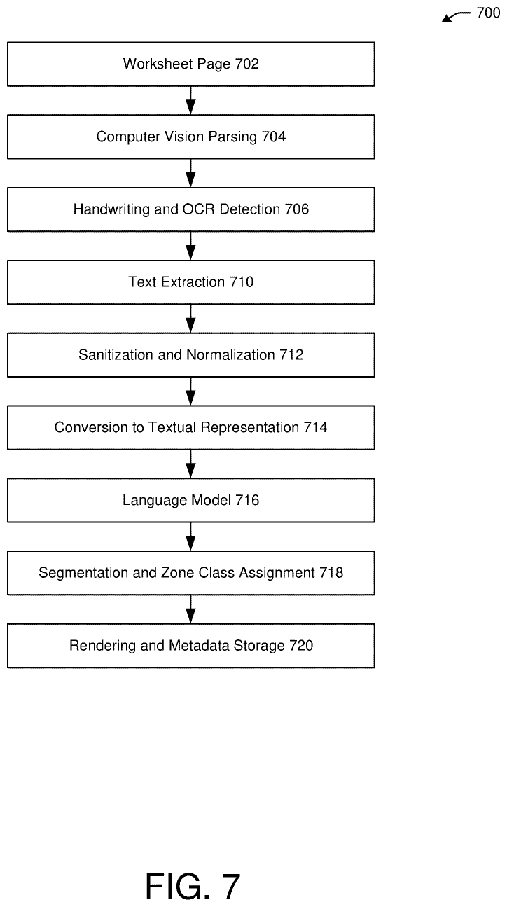

Referring to FIG. 6, the process 600 may include the teacher 404 of FIG. 4 creating or importing a digital document 601 to the device 402, and converting the digital document 601 into a digital worksheet 604 with layers (e.g., the student layers 110 and the teacher layers 112 of FIG. 1.), such as is explained with respect to FIG. 7. The device 402 may connect to a peer-to-peer (P2P) network and cloud storage 602 (e.g., the one or more remote devices 414 of FIG. 4). The teacher 404 may request to run answer zone detection 608 on the device 402, which may use the OCR and AI system 418 of FIG. 4 to detect answer zones 610 (e.g., the answer zones 108 of FIG. 1) in the digital worksheet 604. The device 402 may send a link or QR code to invite 612 the students 408 to their student layers (e.g., by sending the link or QR code to the devices 406). The students 408 may accept the invitation 614 via the devices 406, which may result in the devices 406 joining a network session 616 with the device 402 for sharing data from the layers of the digital worksheet 604.

Still referring to FIG. 6, a copy 618 of the digital worksheet 604 may be provided from the P2P network and cloud storage 602 to the devices 406 (e.g., respective copies of the student layers). The devices 406 may present the respective student layers to the students 408, who may input handwritten answers 620 into the devices 406 (e.g., answers to questions/exercises of the digital worksheet 604). Updated layers 622, representing the respective student layers with their handwritten answers 620, may be uploaded to the P2P network and cloud storage 602, which may perform handwriting detection 624 and answer clustering 626. When the student answers have been aggregated (e.g., based on categories/similarities), an aggregated view 628 may be presented by the device 402 as the teacher layers. The teacher 404 may provide feedback 630 via the device 406 to the answers (e.g., indicating correct/incorrect answers, annotations, etc.). The feedback 630 may be provided by the device 402 to the P2P network and cloud storage 602, which may push the feedback 630 to the devices 406 individually so that each student may view the feedback 630 pertaining to their answers.

FIG. 7 illustrates an example process 700 for grading and feedback of answers that are handwritten using devices, in accordance with one embodiment.

At block 702, a device (or system, e.g., the device 402 of FIG. 4) may receive a worksheet page (e.g., the document 601 of FIG. 6), which may be a computer-readable document created or imported by the teacher 404 of FIG. 4.

At block 704, the device may perform parsing of the worksheet page (e.g., using computer vision). A parsing module may use advanced image processing techniques to identify and isolate different elements in the worksheet page, such as blocks of test, images, and blank spaces.

At block 706, the device may perform handwriting and OCR detection of identified elements of block 704. An OCR module may convert the image data of the text into machine-readable text to allow for the algorithm to understand and interpret the worksheet.

At block 710, the device may perform text extraction to extract machine-readable text from the worksheet page.

At block 712, the device may perform sanitization and normalization of the extracted text. A module may clean the extracted text data, removing irrelevant characters or symbols, and normalizing the text data to a standardized format to ensure that the text data are in a suitable state for further processing.

At block 714, the device may convert the sanitized and normalized characters to a textual representation that may be processed by a language model.

At block 716, the device may input the textual representation to a language model (e.g., a LLM) to predict the answer zones for questions/exercises represented by the textual representations. The language model may be designed to understand the semantic structure of the text, such as sentence structure, grammar, and punctuation, and to use the understanding to identify where questions end and answers begin (e.g., locations of where questions end and locations where answers begin relative to the end of the questions).

At block 718, the device may use the language model to perform segmentation and zone class assignment based on the language model, predicting the amount of space needed for the answer zones of questions based on the categories of the questions as predicted by the language model. The language model may segment the answer zones and assign them a class based on their type (e.g., true/false questions, multiple choice questions, free-form answer questions, fill-in-the-blank questions, etc.).

At block 720, the device may render the questions and answer zones onto the digital worksheet, and may store metadata indicative of the answer zones (e.g., their location on the page, their type, and their associated question) for future reference.

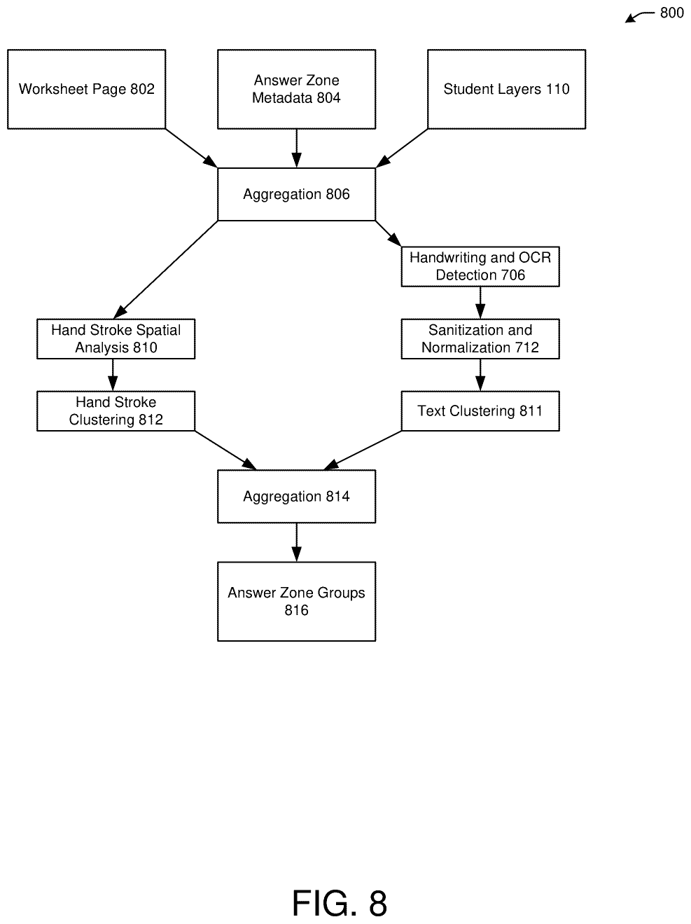

FIG. 8 illustrates an example process 800 for generating answer zone groups, in accordance with one embodiment.

Referring to FIG. 8, a worksheet page 802 (e.g., the digital worksheet 604 of FIG. 6), answer zone metadata 804 (e.g., metadata about the answer zones in the worksheet page 802 and the student layers 110), and the student layers 110 may be aggregated at step 806 into a unified dataset. The answer zone metadata, which was previously stored during the answer zone detection process, provides crucial information about the location and type of each answer zone. The handwriting and OCR detection may be performed on the aggregated data to convert the handwritten answers of the students into machine-readable text, and the sanitization and normalization may be performed on the recognized text to remove any irrelevant characters or symbols and converting all text to a uniform case and format.

Still referring to FIG. 8, the aggregated dataset also may pass through a hand stroke spatial analysis 810. This module may analyze spatial characteristics of the hand strokes used in the digital handwritten answers, such as their direction, curvature, and pressure. This provides additional data usable to differentiate between different student responses. Alternatively or in addition, students may be identified by their user account and student layer to determine which answers were entered by which students. After the text sanitization and normalization and the hand stroke spatial analysis 810, text clustering 811 and hand stroke clustering 812 may be performed. The clustering steps process and group the student answers based on the similarity of their content (e.g., for text clustering 811) and the similarity of their hand strokes (e.g., for hand stroke clustering 812). The results from the clustering steps may be aggregated 814 to form the answer zone groups 816. These groups represent clusters of student responses that are similar in both their content and the spatial location of their handwritten answers. For example, students who chose to circle a particular option in an MCQ will be grouped together based on an analysis of their hand strokes. The clustering techniques herein allow students to enter answers in different ways, such as circling, ticking, writing down an option, and writing down characters representing words as an answer. The clusters may group answers accordingly (e.g., by type of answer).

The automatic answer zone clustering algorithm provides a powerful tool for teachers, enabling them to efficiently grade similar responses together and providing them with valuable insights into the patterns and trends in their students' responses.

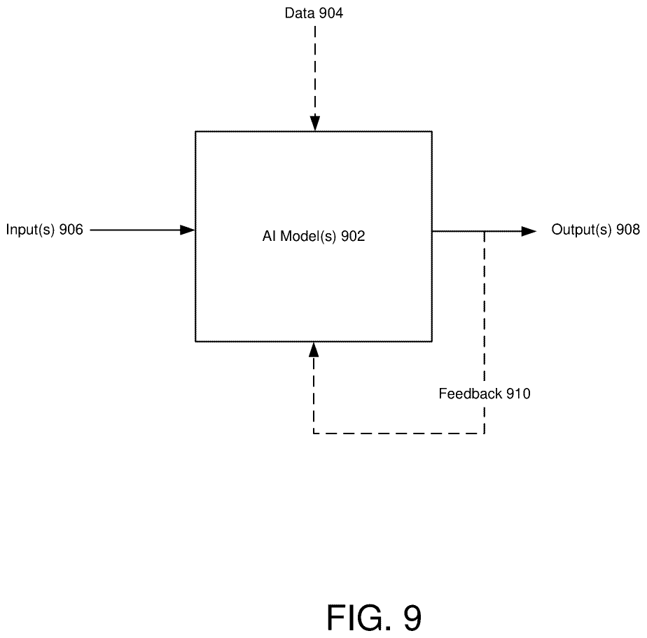

FIG. 9 is an example schematic diagram of one or more artificial intelligence models that may be used for the assessment and correction of text that is handwritten into a computer device, in accordance with one embodiment.

Referring to FIG. 9, one or more artificial intelligence (AI) models 902 (or machine learning models) may be used for any of detecting the handwritten characters, determining that the handwritten characters represent characters, whether the characters represent a question or an answer, similarities and differences between answers, whether the answers are correct/incorrect, and the like. The one or more AI models 902 may receive inputs, optionally may receive data 904 (e.g., training data, one-or few-shot examples, user feedback, etc.), and may generate outputs 908. Optionally, feedback 910 from the outputs 908 may be input into the one or more AI models 902, such as human-in-the-loop feedback, user feedback, comparisons of the outputs 908 to known outputs and their differences (e.g., used to adjust the one or more AI models 902, such as by adjusting weights for identifying characters, answers, hand stroke similarities, text similarities, etc.).

In one or more embodiments, the text identification of handwritten characters may use few-shot learning, one-shot learning, or no-shot learning. In few-shot learning, computer vision and/or natural language processing may be used to recognize, parse, and classify handwritten characters. In one-shot learning, images of handwritten text may be used to identify similarities on the example images and the handwritten text inputs. In zero-shot learning, a machine learning model may not need to be trained, but instead learns the ability to predict handwritten characters.

In one or more embodiments, when the one or more AI models 902 are used to detect handwritten characters, the inputs 906 may be the handwritten strokes and/or characteristics of the handwritten strokes, such as their pixel coordinates on the display with which they were input. The data 904 may include features of characters, such as their coordinates, shapes, sizes, and the like, accounting for different fonts, such as cursive, block letters, etc. The outputs 908 may include the characters identified from the handwritten strokes. The outputs 908 may be re-input to the one or more AI models 902 until the one or more AI models 902 determine that the confidence score assigned to the identified characters exceeds a threshold confidence. The closer the similarities between the inputs 906 and the known characters, for example, the higher the confidence score for identifying the characters.

In one or more embodiments, when the one or more AI models 902 are used for parsing of a digital worksheet, the inputs 906 may include the digital worksheet. The data 904 may include blocks of text, images, and blank spaces. The outputs 908 may include classifications indicating likelihood of portions of the digital worksheet representing blocks of text, images, and blank spaces.

In one or more embodiments, when the one or more AI models 902 are used for the language model, the inputs 906 may include sanitized and normalized text data converted into a textual representation. The data 904 may include text with various semantic structures and corresponding questions and answers (e.g., to identify where questions end and answers begin). The outputs 908 may include answer zones for questions represented by the text. The feedback 910 may include student answers, which may be used to adjust the one or more AI models 902 (e.g., the answer zone sizes, locations, and categories). The data 904 also may include clusters of similar hand strokes and clusters of text with similar content so that the outputs 908 may include the hand stroke clusters and the text clusters.

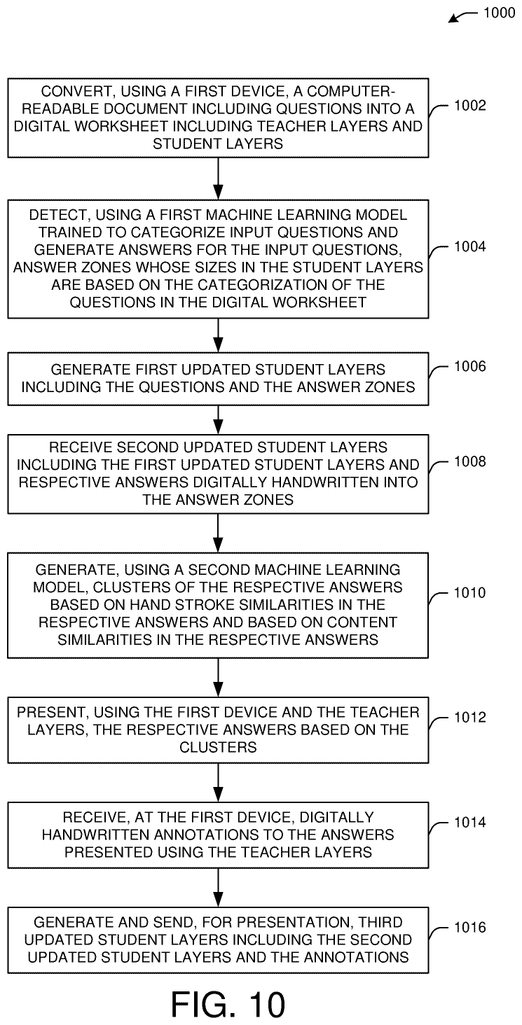

FIG. 10 is a flow for an example process 1000 for artificial intelligence-based grading and feedback of digitally entered handwritten characters into a device, in accordance with one embodiment.

At block 1002, a device (or system, e.g., the device 402 of FIG. 4) may convert a computer-readable document (e.g., a .pdf document or other type of document) that includes questions into a digital worksheet including teacher layers and student layers (e.g., the digital worksheet 604 of FIG. 6).

At block 1004, the device may detect, using a first machine learning model (e.g., the OCR and AI system 418 of FIG. 4, the language model at block 716 of FIG. 7, the one or more AI models 902 of FIG. 9) trained to categorize input questions and generate answers for the input questions, answer zones (e.g., the answer zones 108 of FIG. 1) whose sizes may depend on the categories of questions in the digital worksheet as classified by the first machine learning model.

At block 1006, the device may generate first updated student layers including the questions with the answer zones for presentation to the students. The students may be invited to join a session in which their devices may view their respective student layers with the questions and answer zones. The students may enter digital handwritten strokes into the answer zones as answers.

At block 1008, the device may receive second updated student layers, including the first updated student layers and respective answers from the students as digitally handwritten into the answer zones in the student layers.

At block 1010, the device may generate, using a second machine learning model (the text clustering 811, the hand stroke clustering 812 of FIG. 8, the one or more AI models 902 of FIG. 9), clusters of the respective answers based on hand stroke similarities in the respective answers and based on content similarities in the respective answers.

At block 1012, the device may present, using the teacher layers, the respective answers based on the clustering of answers (e.g., to facilitate batch grading).

At block 1014, the device may receive digitally handwritten annotations to the answers presented using the teacher layers. The annotations may include comments, indications that answers are correct/incorrect, or the like.

At block 1016, the device may generate and send (e.g., to the student devices for presentation) third updated student layers that include the second updated student layers and the annotations.

The examples herein are not meant to be limiting.

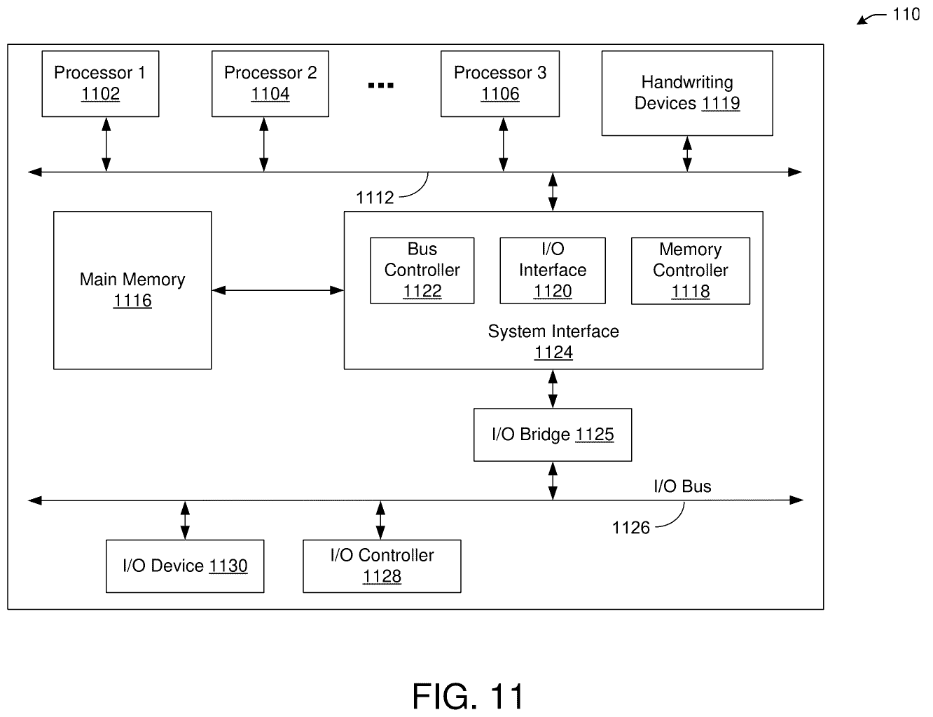

FIG. 11 is a diagram illustrating an example of a computing system 1100 that may be used in implementing embodiments of the present disclosure.

FIG. 11 is a block diagram illustrating an example of a computing device or computer system 1100, which may be used in implementing the embodiments of the components disclosed above. For example, the computing system 1100 of FIG. 11 may represent at least a portion of the device 402, the devices 406, and/or the one or more remote devices 414 of FIG. 4, as discussed above, capable of performing any of the processes of FIGS. 6-8 and 10, and capable of facilitating the Al of FIG. 9. The computer system (system) includes one or more processors 1102-1106. Processors 1102-106 may include one or more internal levels of cache (not shown) and a bus controller 1122 or bus interface unit to direct interaction with the processor bus 1112. Processor bus 1112, also known as the host bus or the front side bus, may be used to couple the processors 1102-1106 with the system interface 1124. System interface 1124 may be connected to the processor bus 1112 to interface other components of the system 1100 with the processor bus 1112. For example, system interface 1124 may include a memory controller 1118 for interfacing a main memory 1116 with the processor bus 1112. The main memory 1116 typically includes one or more memory cards and a control circuit (not shown). System interface 1124 may also include an input/output (I/O) interface 1120 to interface one or more I/O bridges 1125 or I/O devices with the processor bus 1112. One or more I/O controllers and/or I/O devices may be connected with the I/O bus 1126, such as I/O controller 1128 and I/O device 1130, as illustrated. The system 1100 may include one or more handwriting devices 1119 (e.g., representing at least a portion of the user interface modules 416, the OCR and AI system 418, and capable of performing any of the processes of FIGS. 6-8 and 10, and capable of facilitating the AI of FIG. 9).

I/O device 1130 may also include an input device (not shown), such as an alphanumeric input device, including alphanumeric and other keys for communicating information and/or command selections to the processors 1102-1106. Another type of user input device includes cursor control, such as a mouse, a trackball, or cursor direction keys for communicating direction information and command selections to the processors 1102-1106 and for controlling cursor movement on the display device.

System 1100 may include a dynamic storage device, referred to as main memory 1116, or a random access memory (RAM) or other computer-readable devices coupled to the processor bus 1112 for storing information and instructions to be executed by the processors 1102-1106. Main memory 1116 also may be used for storing temporary variables or other intermediate information during execution of instructions by the processors 1102-1106. System 1100 may include a read only memory (ROM) and/or other static storage device coupled to the processor bus 1112 for storing static information and instructions for the processors 1102-1106. The system outlined in FIG. 11 is but one possible example of a computer system that may employ or be configured in accordance with aspects of the present disclosure.

According to one embodiment, the above techniques may be performed by computer system 1100 in response to processor 1104 executing one or more sequences of one or more instructions contained in main memory 1116. These instructions may be read into main memory 1116 from another machine-readable medium, such as a storage device. Execution of the sequences of instructions contained in main memory 1116 may cause processors 1102-1106 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 1106 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 1116, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

The following examples are not meant to be exclusive.

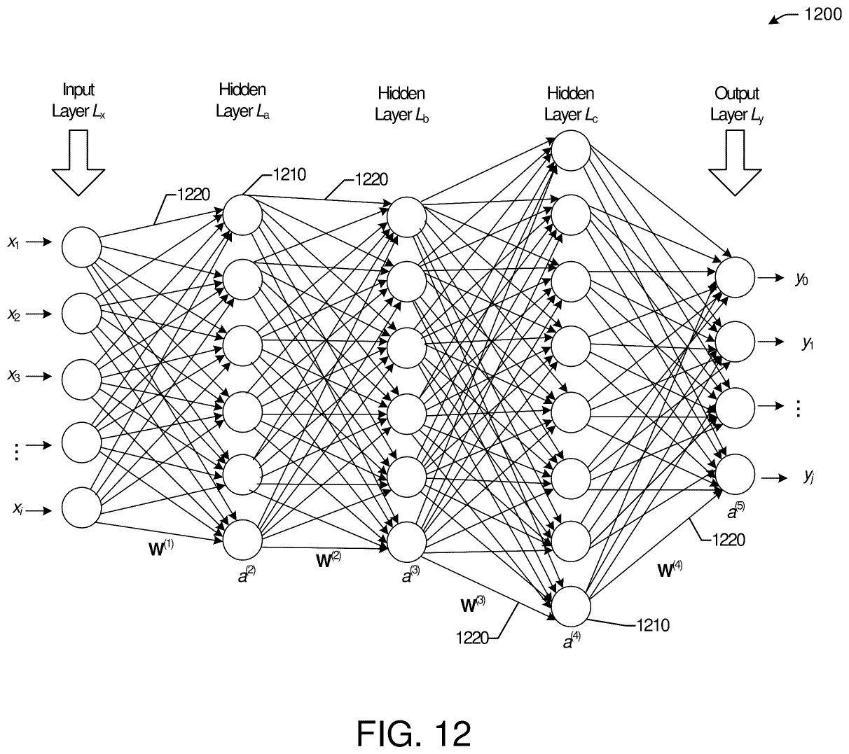

FIG. 12 illustrates an example neural network 1200, in accordance with one or more embodiments. The example neural network (NN) 1200 may represent at least a portion of the AI described in any of the preceding figures.

The neural network (NN) 1200 may be suitable for use by one or more of the computing systems (or subsystems) of the various implementations discussed herein, implemented in part by a HW accelerator, and/or the like. The NN 1200 may be deep neural network (DNN) used as an artificial brain of a compute node or network of compute nodes to handle very large and complicated observation spaces. Additionally or alternatively, the NN 1200 can be some other type of topology (or combination of topologies), such as a convolution NN (CNN), deep CNN (DCN), recurrent NN (RNN), Long Short Term Memory (LSTM) network, a Deconvolutional NN (DNN), gated recurrent unit (GRU), deep belief NN, a feed forward NN (FFN), a deep FNN (DFF), deep stacking network, Markov chain, perception NN, Bayesian Network (BN) or Bayesian NN (BNN), Dynamic BN (DBN), Linear Dynamical System (LDS), Switching LDS (SLDS), Optical NNs (ONNs), an NN for reinforcement learning (RL) and/or deep RL (DRL), and/or the like. NNs are usually used for supervised learning, but can be used for unsupervised learning and/or reinforcement (RL).

The NN 1200 may encompass a variety of ML techniques where a collection of connected artificial neurons 1210 that (loosely) model neurons in a biological brain that transmit signals to other neurons/nodes 1210. The neurons 1210 may also be referred to as nodes 1210, processing elements (PEs) 1210, or the like. The connections 1220 (or edges 1220) between the nodes 1210 are (loosely) modeled on synapses of a biological brain and convey the signals between nodes 1210. Note that not all neurons 1210 and edges 1220 are labeled in FIG. 12 for the sake of clarity.

Each neuron 1210 has one or more inputs and produces an output, which can be sent to one or more other neurons 1210 (the inputs and outputs may be referred to as “signals”). Inputs to the neurons 1210 of the input layer Lₓ can be feature values of a sample of external data (e.g., input variables xᵢ). The input variables xᵢ can be set as a vector containing relevant data (e.g., observations, ML features, and the like). The inputs to hidden units 1210 of the hidden layers Lₐ, L_{b}, and L_{c} may be based on the outputs of other neurons 1210. The outputs of the final output neurons 1210 of the output layer L_{y} (e.g., output variables yⱼ) include predictions, inferences, and/or accomplish a desired/configured task. The output variables yⱼ may be in the form of determinations, inferences, predictions, and/or assessments. Additionally or alternatively, the output variables yⱼ can be set as a vector containing the relevant data (e.g., determinations, inferences, predictions, assessments, and/or the like).

Neurons 1210 may have a threshold such that a signal is sent only if the aggregate signal crosses that threshold. A node 1210 may include an activation function, which defines the output of that node 1210 given an input or set of inputs. Additionally or alternatively, a node 1210 may include a propagation function that computes the input to a neuron 1210 from the outputs of its predecessor neurons 1210 and their connections 1220 as a weighted sum. A bias term can also be added to the result of the propagation function.

The NN 1200 also includes connections 1220, some of which provide the output of at least one neuron 1210 as an input to at least another neuron 1210. Each connection 1220 may be assigned a weight that represents its relative importance. The weights may also be adjusted as learning proceeds. The weight increases or decreases the strength of the signal at a connection 1220.

The neurons 1210 can be aggregated or grouped into one or more layers L where different layers L may perform different transformations on their inputs. In FIG. 12, the NN 1200 comprises an input layer Lₓ, one or more hidden layers Lₐ, L_{b}, and L_{c}, and an output layer L_{y} (where a, b, c, x, and y may be numbers), where each layer L comprises one or more neurons 1210. Signals travel from the first layer (e.g., the input layer L₁), to the last layer (e.g., the output layer L_{y}), possibly after traversing the hidden layers Lₐ, L_{b}, and L_{c} multiple times. In FIG. 12, the input layer Lₐ receives data of input variables xᵢ (where i=1, . . . , p, where p is a number). Hidden layers Lₐ, L_{b}, and L_{c} processes the inputs xᵢ, and eventually, output layer L_{y} provides output variables yⱼ (where j=1, . . . , p′, where p′ is a number that is the same or different than p). In the example of Figure an, for simplicity of illustration, there are only three hidden layers Lₐ, L_{b}, and L_{c} in the NN 1200, however, the NN 1200 may include many more (or fewer) hidden layers Lₐ, L_{b}, and L_{c} than are shown.

In the context of ML, an “ML feature” (or simply “feature”) is an individual measurable property or characteristic of a phenomenon being observed. Features are usually represented using numbers/numerals (e.g., integers), strings, variables, ordinals, real-values, categories, and/or the like. Additionally or alternatively, ML features are individual variables, which may be independent variables, based on observable phenomenon that can be quantified and recorded. ML models use one or more features to make predictions or inferences. In some implementations, new features can be derived from old features.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

The term “application” may refer to a complete and deployable package, environment to achieve a certain function in an operational environment. The term “AI/ML application” or the like may be an application that contains some AI/ML models and application-level descriptions.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware clement(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “feature” at least in some examples refers to an individual measurable property, quantifiable property, or characteristic of a phenomenon being observed. Additionally or alternatively, the term “feature” at least in some examples refers to an input variable used in making predictions. At least in some examples, features may be represented using numbers/numerals (e.g., integers), strings, variables, ordinals, real-values, categories, and/or the like.

The term “feature engineering” at least in some examples refers to a process of determining which features might be useful in training an ML model, and then converting raw data into the determined features. Feature engineering is sometimes referred to as “feature extraction.”

The term “feature extraction” at least in some examples refers to a process of dimensionality reduction by which an initial set of raw data is reduced to more manageable groups for processing. Additionally or alternatively, the term “feature extraction” at least in some examples refers to retrieving intermediate feature representations calculated by an unsupervised model or a pretrained model for use in another model as an input. Feature extraction is sometimes used as a synonym of “feature engineering.”

The term “feature map” at least in some examples refers to a function that takes feature vectors (or feature tensors) in one space and transforms them into feature vectors (or feature tensors) in another space. Additionally or alternatively, the term “feature map” at least in some examples refers to a function that maps a data vector (or tensor) to feature space. Additionally or alternatively, the term “feature map” at least in some examples refers to a function that applies the output of one filter applied to a previous layer. In some embodiments, the term “feature map” may also be referred to as an “activation map”.

The term “feature vector” at least in some examples, in the context of ML, refers to a set of features and/or a list of feature values representing an example passed into a model. Additionally or alternatively, the term “feature vector” at least in some examples, in the context of ML, refers to a vector that includes a tuple of one or more features.

The term “forward propagation” or “forward pass” at least in some examples, in the context of ML, refers to the calculation and storage of intermediate variables (including outputs) for a neural network in order from the input layer to the output layer.

The term “hidden layer”, in the context of ML and NNs, at least in some examples refers to an internal layer of neurons in an ANN that is not dedicated to input or output. The term “hidden unit” refers to a neuron in a hidden layer in an ANN.

The term “hyperparameter” at least in some examples refers to characteristics, properties, and/or parameters for an ML process that cannot be learnt during a training process. Hyperparameter are usually set before training takes place, and may be used in processes to help estimate model parameters. Examples of hyperparameters include model size (e.g., in terms of memory space, bytes, number of layers, and the like); training data shuffling (e.g., whether to do so and by how much); number of evaluation instances, iterations, epochs (e.g., a number of iterations or passes over the training data), or episodes; number of passes over training data; regularization; learning rate (e.g., the speed at which the algorithm reaches (converges to) optimal weights); learning rate decay (or weight decay); momentum; number of hidden layers; size of individual hidden layers; weight initialization scheme; dropout and gradient clipping thresholds; the C value and sigma value for SVMs; the k in k-nearest neighbors; number of branches in a decision tree; number of clusters in a clustering algorithm; vector size; word vector size for NLP and NLU; and/or the like.

The term “inference engine” at least in some examples refers to a component of a computing system that applies logical rules to a knowledge base to deduce new information.

The terms “instance-based learning” or “memory-based learning” in the context of ML at least in some examples refers to a family of learning algorithms that, instead of performing explicit generalization, compares new problem instances with instances seen in training, which have been stored in memory. Examples of instance-based algorithms include k-nearest neighbor, and the like), decision tree Algorithms (e.g., Classification And Regression Tree (CART), Iterative Dichotomiser 3 (ID3), C4.5, chi-square automatic interaction detection (CHAID), and the like), Fuzzy Decision Tree (FDT), and the like), Support Vector Machines (SVM), Bayesian Algorithms (e.g., Bayesian network (BN), a dynamic BN (DBN), Naive Bayes, and the like), and ensemble algorithms (e.g., Extreme Gradient Boosting, voting ensemble, bootstrap aggregating (“bagging”), Random Forest and the like.

The term “loss function” or “cost function” at least in some examples refers to an event or values of one or more variables onto a real number that represents some “cost” associated with the event. A value calculated by a loss function may be referred to as a “loss” or “error”. Additionally or alternatively, the term “loss function” or “cost function” at least in some examples refers to a function used to determine the error or loss between the output of an algorithm and a target value. Additionally or alternatively, the term “loss function” or “cost function” at least in some examples refers to a function are used in optimization problems with the goal of minimizing a loss or error.

The term “mathematical model” at least in some examples refer to a system of postulates, data, and inferences presented as a mathematical description of an entity or state of affairs including governing equations, assumptions, and constraints. The term “statistical model” at least in some examples refers to a mathematical model that embodies a set of statistical assumptions concerning the generation of sample data and/or similar data from a population; in some examples, a “statistical model” represents a data-generating process.

The term “machine learning” or “ML” at least in some examples refers to the use of computer systems to optimize a performance criterion using example (training) data and/or past experience. ML involves using algorithms to perform specific task(s) without using explicit instructions to perform the specific task(s), and/or relying on patterns, predictions, and/or inferences. ML uses statistics to build ML model(s) (also referred to as “models”) in order to make predictions or decisions based on sample data (e.g., training data).

The term “machine learning model” or “ML model” at least in some examples refers to an application, program, process, algorithm, and/or function that is capable of making predictions, inferences, or decisions based on an input data set and/or is capable of detecting patterns based on an input data set. In some examples, a “machine learning model” or “ML model” is trained on a training data to detect patterns and/or make predictions, inferences, and/or decisions. In some examples, a “machine learning model” or “ML model” is based on a mathematical and/or statistical model. For purposes of the present disclosure, the terms “ML model”, “AI model”, “AI/ML model”, and the like may be used interchangeably.

The term “machine learning algorithm” or “ML algorithm” at least in some examples refers to an application, program, process, algorithm, and/or function that builds or estimates an ML model based on sample data or training data. Additionally or alternatively, the term “machine learning algorithm” or “ML algorithm” at least in some examples refers to a program, process, algorithm, and/or function that learns from experience w.r.t some task(s) and some performance measure(s)/metric(s), and an ML model is an object or data structure created after an ML algorithm is trained with training data. For purposes of the present disclosure, the terms “ML algorithm”, “AI algorithm”, “AI/ML algorithm”, and the like may be used interchangeably. Additionally, although the term “ML algorithm” may refer to different concepts than the term “ML model,” these terms may be used interchangeably for the purposes of the present disclosure.

The term “machine learning application” or “ML application” at least in some examples refers to an application, program, process, algorithm, and/or function that contains some AI/ML model(s) and application-level descriptions. Additionally or alternatively, the term “machine learning application” or “ML application” at least in some examples refers to a complete and deployable application and/or package that includes at least one ML model and/or other data capable of achieving a certain function and/or performing a set of actions or tasks in an operational environment. For purposes of the present disclosure, the terms “ML application”, “AI application”, “AI/ML application”, and the like may be used interchangeably.

The term “machine learning entity” or “ML entity” at least in some examples refers to an entity that is either an ML model or contains an ML model and ML model-related metadata that can be managed as a single composite entity (in some examples, metadata may include, for example, the applicable runtime context for the ML model). For purposes of the present disclosure, the term “AI/ML entity” or “ML entity” at least in some examples refers to an entity that is either an AI/ML model and/or contains an AI/ML model and that can be managed as a single composite entity. Additionally, the term “ML entity training” at least in some examples refers to ML model training associated with an ML entity. Moreover, the term “AI/ML” may be used interchangeably with the terms “Al” and “ML” throughout the present disclosure.

The term “AI decision entity”, “machine learning decision entity”, or “ML decision entity” at least in some examples refers to an entity that applies a non-AI and/or non-ML based logic for making decisions that can be managed as a single composite entity.

The term “machine learning training”, “ML training”, or “MLT” at least in some examples refers to capabilities and associated end-to-end (e2e) processes to enable an ML training function to perform ML entity (or ML model) training (e.g., as defined herein). In some examples, ML training capabilities include interaction with other parties/entities to collect and/or format the data required for ML model training. Additionally or alternatively, “training an ML entity” refers to training one or more ML model(s) associated with an ML entity internally by an MLT function.

The term “machine learning model training” or “ML model training” at least in some examples refers to capabilities of an ML training function to take data, run the data through an ML model, derive associated loss, optimization, and/or objective/goal, and adjust the parameterization of the ML model based on the computed loss, optimization, and/or objective/goal.

The term “ML initial training” at least in some examples refers to ML entity training that generates an initial version of a trained ML entity.

The term “ML re-training” at least in some examples refers to MLT that generates a new version of a trained ML entity using the same type, but different values or distributions, of training data as that used to train the previous version of the ML entity. This new version of the trained ML entity (e.g., the re-trained ML entity) supports the same type of inference as the previous version of the ML entity, e.g., the data type of inference input and data type of inference output remain unchanged between the two versions of the ML entity.

The term “machine learning training function”, “ML training function”, or “MLT function” at least in some examples refers to a (logical) function with MLT capabilities.

The term “AI/ML inference function” or “ML inference function” at least in some examples refers to a (logical) function (or set of functions) that employs an ML model and/or AI decision entity to conduct inference. Additionally or alternatively, the term “AI/ML inference function” or “ML inference function” at least in some examples refers to an inference framework used to run a compiled model in the inference host. In some examples, an “AI/ML inference function” or “ML inference function” may also be referred to an “model inference engine”, “ML inference engine”, or “inference engine”.

The term “machine learning workflow” or “ML workflow” at least in some examples refers to a process including data collection and preparation, AI/ML model building/generation; ML model training and testing; ML model deployment, ML model execution, ML model validation and/or verification; continuous, periodic and/or asynchronous ML model monitoring; ML model tuning, learning, and/or retraining. In some examples, the ML model monitoring includes self-monitoring or autonomous monitoring). In some examples, the ML model tuning, learning, and/or retraining includes self-tuning (or autonomous tuning), self-learning (or autonomous learning), and/or self-retraining (or autonomous retraining). The term “machine learning lifecycle” or “ML lifecycle” at least in some examples refers to process(es) of planning and/or managing the development, deployment, instantiation, and/or termination of an ML model and/or individual ML model components.

The term “matrix” at least in some examples refers to a rectangular array of numbers, symbols, or expressions, arranged in rows and columns, which may be used to represent an object or a property of such an object.

The terms “model parameter” and/or “parameter” in the context of ML, at least in some examples refer to values, characteristics, and/or properties that are learnt during training. Additionally or alternatively, “model parameter” and/or “parameter” in the context of ML, at least in some examples refer to a configuration variable that is internal to the model and whose value can be estimated from the given data. Model parameters are usually required by a model when making predictions, and their values define the skill of the model on a particular problem. Examples of such model parameters/parameters include weights (e.g., in an ANN); constraints; support vectors in a support vector machine (SVM); coefficients in a linear regression and/or logistic regression; word frequency, sentence length, noun or verb distribution per sentence, the number of specific character n-grams per word, lexical diversity, and the like, for natural language processing (NLP) and/or natural language understanding (NLU); and/or the like.

The terms “regression algorithm” and/or “regression analysis” in the context of ML at least in some examples refers to a set of statistical processes for estimating the relationships between a dependent variable (often referred to as the “outcome variable”) and one or more independent variables (often referred to as “predictors”, “covariates”, or “features”). Examples of regression algorithms/models include logistic regression, linear regression, gradient descent (GD), stochastic GD (SGD), and the like.

The term “reinforcement learning” or “RL” at least in some examples refers to a goal-oriented learning technique based on interaction with an environment. In RL, an agent aims to optimize a long-term objective by interacting with the environment based on a trial and error process. Examples of RL algorithms include Markov decision process, Markov chain, Q-learning, multi-armed bandit learning, temporal difference learning, and deep RL. The term “multi-armed bandit problem”, “K-armed bandit problem”, “N-armed bandit problem”, or “contextual bandit” at least in some examples refers to a problem in which a fixed limited set of resources must be allocated between competing (alternative) choices in a way that maximizes their expected gain, when each choice's properties are only partially known at the time of allocation, and may become better understood as time passes or by allocating resources to the choice. The term “contextual multi-armed bandit problem” or “contextual bandit” at least in some examples refers to a version of multi-armed bandit where, in each iteration, an agent has to choose between arms; before making the choice, the agent sees a d-dimensional feature vector (context vector) associated with a current iteration, the learner uses these context vectors along with the rewards of the arms played in the past to make the choice of the arm to play in the current iteration, and over time the learner's aim is to collect enough information about how the context vectors and rewards relate to each other, so that it can predict the next best arm to play by looking at the feature vectors.

The term “reward function”, in the context of RL, at least in some examples refers to a function that outputs a reward value based on one or more reward variables; the reward value provides feedback for an RL policy so that an RL agent can learn a desirable behavior. The term “reward shaping”, in the context of RL, at least in some examples refers to adjusting or altering a reward function to output a positive reward for desirable behavior and a negative reward for undesirable behavior.

The term “supervised learning” at least in some examples refers to an ML technique that aims to learn a function or generate an ML model that produces an output given a labeled data set. Supervised learning algorithms build models from a set of data that contains both the inputs and the desired outputs. For example, supervised learning involves learning a function or model that maps an input to an output based on example input-output pairs or some other form of labeled training data including a set of training examples. Each input-output pair includes an input object (e.g., a vector) and a desired output object or value (referred to as a “supervisory signal”). Supervised learning can be grouped into classification algorithms, regression algorithms, and instance-based algorithms.

The term “tensor” at least in some examples refers to an object or other data structure represented by an array of components that describe functions relevant to coordinates of a space. Additionally or alternatively, the term “tensor” at least in some examples refers to a generalization of vectors and matrices and/or may be understood to be a multidimensional array. Additionally or alternatively, the term “tensor” at least in some examples refers to an array of numbers arranged on a regular grid with a variable number of axes. At least in some examples, a tensor can be defined as a single point, a collection of isolated points, or a continuum of points in which elements of the tensor are functions of position, and the Tensor forms a “tensor field”. At least in some examples, a vector may be considered as a one dimensional (1D) or first order tensor, and a matrix may be considered as a two dimensional (2D) or second order tensor. Tensor notation may be the same or similar as matrix notation with a capital letter representing the tensor and lowercase letters with subscript integers representing scalar values within the tensor.

The term “tuning” or “tune” at least in some examples refers to a process of adjusting model parameters or hyperparameters of an ML model in order to improve its performance. Additionally or alternatively, the term “tuning” or “tune” at least in some examples refers to optimizing an ML model's model parameters and/or hyperparameters. In some examples, the particular model parameters and/or hyperparameters that are selected for adjustment, and the optimal values for the model parameters and/or hyperparameters vary depending on various aspects of the ML model, the training data, ML application and/or use cases, and/or other parameters, conditions, or criteria.

The term “unsupervised learning” at least in some examples refers to an ML technique that aims to learn a function to describe a hidden structure from unlabeled data. Unsupervised learning algorithms build models from a set of data that contains only inputs and no desired output labels. Unsupervised learning algorithms are used to find structure in the data, like grouping or clustering of data points. Examples of unsupervised learning are K-means clustering, principal component analysis (PCA), and topic modeling, among many others. The term “semi-supervised learning” at least in some examples refers to ML algorithms that develop ML models from incomplete training data, where a portion of the sample input does not include labels.

What is claimed:

1. A method for artificial intelligence-based grading and feedback of digitally entered handwritten characters into a device, the method comprising:
converting, using a first device, a computer-readable document comprising questions into a digital worksheet comprising teacher layers and student layers, wherein the teacher layers and the student layers each comprise the questions;
detecting, using a first machine learning model trained to categorize input questions and generate answer zones for the input questions, answer zones whose sizes in the student layers are based on the categorization of the questions of the digital worksheet;
generating first updated student layers comprising the questions and the answer zones;
receiving second updated student layers comprising the first updated student layers and respective answers digitally handwritten into the answer zones;
generating, using a second machine learning model, clusters of the respective answers based on hand stroke similarities in the respective answers and based on content similarities in the respective answers; and
presenting, using the first device and the teacher layers, the respective answers based on the clusters.

2. The method of claim 1, further comprising:
receiving, at the first device, digitally handwritten annotations to the answers presented using the teacher layers;
generating third updated student layers comprising the second updated student layers and the annotations; and
sending the third updated student layers for presentation.

3. The method of claim 1, wherein the first machine learning model categorizes the questions in the digital worksheet as true or false questions, multiple choice questions, free-form answer questions, and fill-in-the-blank questions, wherein respective sizes of the answer zones are the same when respective answer zones correspond to a same category of questions, and wherein respective sizes of the answer zones differ when respective answer zones correspond to a different category of questions.

4. The method of claim 1, wherein one or more first student layers of the student layers is for a first student and is not viewable by any other students.

5. The method of claim 4, wherein presenting the respective answers based on the clusters comprises presenting first respective answers, from the student layers, to a first respective questions in sequential order with second respective answers, from the student layers, to a second respective question.

6. The method of claim 5, wherein presenting the respective answers based on the clusters comprises presenting a first cluster of the first respective answers prior to a second cluster of the first respective answers.

7. The method of claim 6, wherein the first cluster consist of correct answers, and wherein the second cluster consist of incorrect answers.

8. The method of claim 1, wherein the hand stroke similarities comprise at least one of text direction, curvature, and pressure used to digitally enter the respective answers.

9. A system for artificial intelligence-based grading and feedback of digitally entered handwritten characters into a device, the system comprising memory coupled to at least one processor, the at least one processor configured to:
convert, using a first device, a computer-readable document comprising questions into a digital worksheet comprising teacher layers and student layers, wherein the teacher layers and the student layers each comprise the questions;
detect, using a first machine learning model trained to categorize input questions and generate answer zones for the input questions, answer zones whose sizes in the student layers are based on the categorization of the questions of the digital worksheet;
generate first updated student layers comprising the questions and the answer zones;
receive second updated student layers comprising the first updated student layers and respective answers digitally handwritten into the answer zones;
generate, using a second machine learning model, clusters of the respective answers based on hand stroke similarities in the respective answers and based on content similarities in the respective answers; and
present, using the first device and the teacher layers, the respective answers based on the clusters.

10. The system of claim 9, wherein the at least one processor is further configured to:
receive, at the first device, digitally handwritten annotations to the answers presented using the teacher layers;
generate third updated student layers comprising the second updated student layers and the annotations; and
send the third updated student layers for presentation.

11. The system of claim 9, wherein the first machine learning model categorizes the questions in the digital worksheet as true or false questions, multiple choice questions, free-form answer questions, and fill-in-the-blank questions, wherein respective sizes of the answer zones are the same when respective answer zones correspond to a same category of questions, and wherein respective sizes of the answer zones differ when respective answer zones correspond to a different category of questions.

12. The system of claim 9, wherein one or more first student layers of the student layers is for a first student and is not viewable by any other students.

13. The system of claim 12, wherein to present the respective answers based on the clusters comprises presenting first respective answers, from the student layers, to a first respective questions in sequential order with second respective answers, from the student layers, to a second respective question.

14. The system of claim 13, wherein to present the respective answers based on the clusters comprises to present a first cluster of the first respective answers prior to a second cluster of the first respective answers.

15. The system of claim 14, wherein the first cluster consist of correct answers, and wherein the second cluster consist of incorrect answers.

16. The system of claim 9, wherein the hand stroke similarities comprise at least one of text direction, curvature, and pressure used to digitally enter the respective answers.

17. A non-transitory computer-readable storage medium comprising instructions to cause at least one processor for artificial intelligence-based grading and feedback of digitally entered handwritten characters into a device, upon execution of the instructions by the at least one processor, to:
convert, using a first device, a computer-readable document comprising questions into a digital worksheet comprising teacher layers and student layers, wherein the teacher layers and the student layers each comprise the questions;
detect, using a first machine learning model trained to categorize input questions and generate answer zones for the input questions, answer zones whose sizes in the student layers are based on the categorization of the questions of the digital worksheet;
generate first updated student layers comprising the questions and the answer zones;
receive second updated student layers comprising the first updated student layers and respective answers digitally handwritten into the answer zones;
generate, using a second machine learning model, clusters of the respective answers based on hand stroke similarities in the respective answers and based on content similarities in the respective answers; and
present, using the first device and the teacher layers, the respective answers based on the clusters.

18. The non-transitory computer-readable storage medium of claim 17, wherein execution of the instructions further causes the at least one processor to:
receive, at the first device, digitally handwritten annotations to the answers presented using the teacher layers;
generate third updated student layers comprising the second updated student layers and the annotations; and
send the third updated student layers for presentation.

19. The non-transitory computer-readable storage medium of claim 17, wherein the first machine learning model categorizes the questions in the digital worksheet as true or false questions, multiple choice questions, free-form answer questions, and fill-in-the-blank questions, wherein respective sizes of the answer zones are the same when respective answer zones correspond to a same category of questions, and wherein respective sizes of the answer zones differ when respective answer zones correspond to a different category of questions.

20. The non-transitory computer-readable storage medium of claim 17, wherein one or more first student layers of the student layers is for a first student and is not viewable by any other students.
